(19) United States
(12) Patent Application Publication
(10) Pub. No.: US 2017/0062001 A1
(43) Pub. Date: Mar. 2, 2017

(54) METHOD OF EVALUATING SCRATCH MARK OF MAGNETIC RECORDING MEDIUM AND METHOD OF MANUFACTURING MAGNETIC RECORDING MEDIUM

(71) Applicant: Kabushiki Kaisha Toshiba, Tokyo (JP)

(72) Inventors: Akira Watanabe, Kawasaki Kanagawa (JP); Tsuyoshi Onitsuka, Hino Tokyo (JP); Hiroyuki Hyodo, Yokohama Kanagawa (JP)

(21) Appl. No.: 14/757,456

(22) Filed: Dec. 23, 2015

(30) Foreign Application Priority Data
Aug. 28, 2015 (JP) 2015-169074

(51) Int. Cl. G11B 19/04; G01N 21/95

(52) U.S. Cl. CPC G11B 19/048; G01N 21/95; G01N 2201/06113

(57) ABSTRACT

According to one embodiment, a method of evaluating a scratch mark includes, for a magnetic recording medium including a magnetic recording layer containing magnetic particles and a metal oxide grain boundary provided between the magnetic particles, detecting and evaluating a scratch mark based on information about the reflection intensity of light in a predetermined wavelength range. The predetermined wavelength range includes at least a second wavelength range from 600 nm to 700 nm and a first wavelength range from 300 nm to 500 nm.

### CROSS-REFERENCE TO RELATED APPLICATIONS

This application is based upon and claims the benefit of priority from Japanese Patent Application No. 2015-169074, filed Aug. 28, 2015, the entire contents of which are incorporated herein by reference.

### FIELD

Embodiments described herein relate generally to a method of evaluating the scratch mark of a magnetic recording medium and a method of manufacturing a magnetic recording medium.

### BACKGROUND

Conventionally, defects on the surface of a magnetic recording medium are inspected by evaluating the static magnetic characteristic and residual magnetization of the medium using Young's modulus evaluation by indentation, static magnetic property of the medium using MOKE (magneto-optical Kerr effect), or MFM (Magnetic Force Microscope) measurement.

For example, the Young's modulus by indentation is greatly affected by the Young's modulus of an underlayer. Hence, if, for example, the underlayer is changed, the value largely changes. For this reason, it is difficult to estimate characteristics of scratch mark of a medium by the Young's modulus, when a material of the underlayer is changed. In addition, to measure the Young's modulus of each layer, a layer to be measured need to be deposited to about 40 nm. This film thickness is different from that of a film used in an actual product. Hence, the crystallinity, orientation, and the like may change, and the Young's modulus may also change. For this reason, the method is not suitable as a method of evaluating the scratch mark of a medium, as can be seen.

Alternatively, when evaluating the degree of signal degradation of a pattern recorded on a medium by scratches and MFM, residual magnetization of a recording layer is evaluated. Hence, the scratch mark of each medium can directly be evaluated. To do this, however, it is necessary to record a pattern on a manufactured medium and perform scratch evaluation, MFM evaluation, and the like for that portion, resulting in an enormous time.

### BRIEF DESCRIPTION OF THE DRAWINGS

FIG. 1 is a graph showing the relationship between a reflection intensity and a scratch mark depth;

FIG. 2 is a graph showing the relationship between a reflection intensity and a magnetic characteristic;

FIG. 3 is a sectional view schematically showing a magnetic recording medium before deformation;

FIG. 4 is a sectional view schematically showing an example of a scratch mark provided on the magnetic recording medium;

FIG. 5 is a sectional view schematically showing another example of a scratch mark provided on the magnetic recording medium;

FIG. 6 is a graph showing the relationship between a pointing vector and a depth from the surface of the magnetic recording medium for each wavelength of light;

FIG. 7 is a graph showing the relationship between an incident light wavelength and a normalized vertical reflectance with respect to the depth of a scratch mark in mode 1;

FIG. 8 is a graph showing a vertical reflectance in a wavelength range from 600 nm to 700 nm on a mode basis;

FIG. 9 is a schematic view for explaining a mechanism configured to increase the vertical reflectance in a wavelength range from 600 nm to 700 nm;

FIG. 10 is a schematic view for explaining a mechanism configured to increase the vertical reflectance in a wavelength range from 600 nm to 700 nm;

FIG. 11 is a schematic view for explaining a mechanism configured to increase the vertical reflectance in a wavelength range from 600 nm to 700 nm; and

FIG. 12 is a graph showing the relationship between the film thickness of a granular layer and a normalized vertical reflectance at wavelengths of 300 nm and 700 nm.

### DETAILED DESCRIPTION

A scratch mark evaluation method according to an embodiment includes forming a test scratch mark on a magnetic recording medium including a magnetic recording layer containing magnetic particles and a metal oxide grain boundary provided between the magnetic particles, and evaluating a scratch mark based on information about a reflection intensity of light in a predetermined wavelength range on the obtained scratch mark. The predetermined wavelength range includes at least a second wavelength range from 600 nm to 700 nm, and can further include a first wavelength range from 300 nm to 500 nm.

The method according to the embodiment includes applying the magnetic recording medium with the scratch mark to an optical inspection apparatus including a light source capable of emitting at least light in the second wavelength range from 600 nm to 700 nm and preferably further emitting light in the first wavelength range from 300 nm to 500 nm, and measuring a second reflection intensity of the light in the second wavelength range on the scratch mark, and a first reflection intensity of the light in the first wavelength range, as needed, to obtain information about the first reflection intensity in the first wavelength range and the second reflection intensity in the second wavelength range.

Note that the scratch mark is a defect such as a flaw, stamp and indentation and all formed on the medium surface.

The optical inspection apparatus can include a first light source configured to emit light in the first wavelength range, and a second light source configured to emit light in the second wavelength range.

Alternatively, the optical inspection apparatus can include a light source configured to emit light including light in the first wavelength range and light in the second wavelength range.

An example of the light source configured to emit light including light in the first wavelength range and light in the second wavelength range is a white light source.

For example, the magnetic recording medium with the scratch mark can be applied to an optical microscope including a white light source. The scratch mark on the surface of the magnetic recording medium is captured using the optical microscope, and an obtained image signal is separated into a blue signal or an optical signal in a wavelength range of, for example, 430 to 490 nm, a green signal or an optical signal in a wavelength range of, for example, 490 to 550 nm, and a red signal or an optical signal in a wavelength range of, for example, 640 to 770 nm. The scratch mark on the surface of the magnetic recording medium can be evaluated based on the separated blue, green, and red signals. The blue, green, and red signals include at least information equal to the information about the first reflection intensity in the first wavelength range from 300 nm to 500 nm and the second reflection intensity in the second wavelength range from 600 nm to 700 nm.

As the light source, a laser microscope that emits a laser beam in the first wavelength range from 300 nm to 500 nm and the second wavelength range from 600 nm to 700 nm is usable.

When the laser microscope is used as the light source, the scratch mark can easily be evaluated by decreasing the number of scratches to about 3, that is ⅕ the conventional number of scratches and evaluating the reflection intensity of that portion.

The forming the test scratch mark can be performed using an indenter, an atomic force microscope (AFM), particle injection, or the like.

A method of manufacturing a magnetic recording medium according to the embodiment includes:

creating a magnetic recording medium including a magnetic recording layer containing magnetic particles and a metal oxide grain boundary provided between the magnetic particles;

forming a test scratch mark on the magnetic recording medium;

applying the magnetic recording medium with the scratch mark to an optical inspection apparatus that emits at least light in a second wavelength range from 600 nm to 700 nm and also emits light in a first wavelength range from 300 nm to 500 nm, and measuring a second reflection intensity of the light in the second wavelength range on the scratch mark, and a first reflection intensity of the light in the first wavelength range, as needed; and

evaluating a scratch mark of the magnetic recording medium based on a measurement result of the first reflection intensity and the second reflection intensity.

According to the scratch mark evaluation method of the embodiment, it is possible to easily evaluate the scratch mark only by obtaining information about the reflection intensity of light in a predetermined wavelength range without measuring a magnetic characteristic.

The embodiment will now be described in more detail with reference to the accompanying drawings.

About Reflection Intensity

To evaluate the scratch mark, 15 scratches each having a length of 8 μm were formed on a medium at an interval of 0.5 μm under a load of 400 μN, 450 μN, or 500 μN using a triboindenter available from Hysitron. After that, the reflection intensity of each scratch portion was measured using an optical microscope. Each obtained image was processed using image processing software (ImageJ), and the reflection intensity on each scratch under white light was calculated based on the contrast of the image.

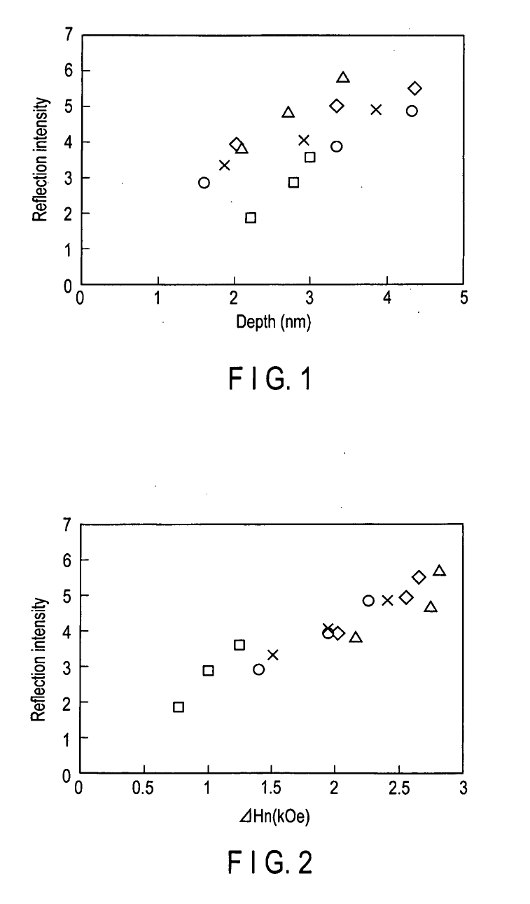

FIG. 1 is a graph showing the relationship between the obtained reflection intensity and a flaw depth calculated by shape measurement using B: atomic force microscope (AFM).

FIG. 2 is a graph showing the relationship between the obtained reflection intensity and the degree of degradation of a magnetic characteristic by C: MOKE measurement.

In FIGS. 1 and 2, each marker represents a medium of a different material and film thickness. FIGS. 1 and 2 show examples in which the flaw depth of a scratch mark formed on each medium, the reflectance intensity of each scratch mark portion, and the degree of degradation of a static magnetic characteristic were measured. The scratches were formed under a condition that 15 scratches were formed at an interval of 500 nm under a load of 400 μN, 450 μN, or 500 μN using a triboindenter.

As is apparent from FIG. 2, the reflection intensity has a high correlation with the degree of degradation of the static magnetic characteristic that is the guideline of scratch mark evaluation. However, as is apparent from FIG. 1, the reflection intensity also exhibits a positive correlation with the flaw depth, and the reflection intensity of white light has a correlation with both the depth of the scratch mark and the amount of degradation of the magnetic characteristic. In the evaluation method according to the embodiment, they are separated, thereby sorting only a flaw that degrades the characteristic of the magnetic recording medium.

Separation of Unevenness Information and Internal Crystal Structure

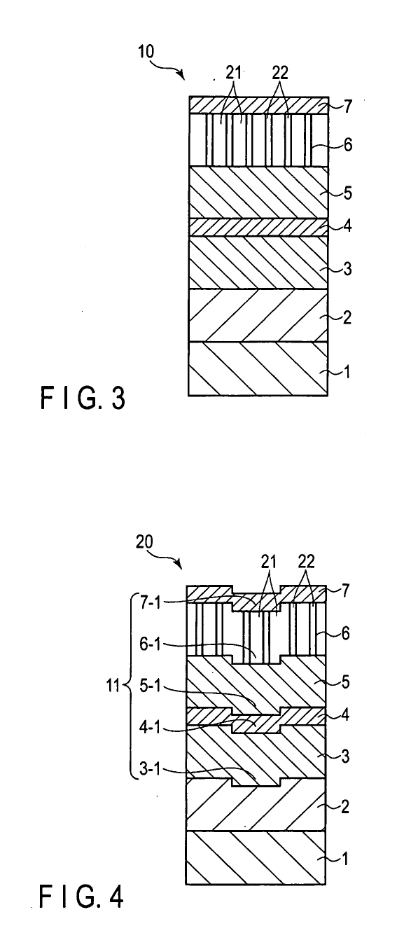

FIG. 3 is a sectional view schematically showing the magnetic recording medium before deformation.

A magnetic recording medium 10 has a structure in which a 10-μm thick Ni plating layer 2, a soft magnetic underlayer 3 made of a 30-nm thick Co layer, a 4-nm thick underlayer 4 containing Ni:W:Pt at an atomic ratio of 1:1:1, a 19-nm thick Ru intermediate layer 5, a 17-nm thick granular magnetic layer 6 containing magnetic particles made of a CoCrPt alloy and an SiO₂-based grain boundary, and a 3-nm thick protective layer 7 made of diamond like carbon are sequentially stacked on an about 1.2-mm thick aluminum substrate 1.

FIG. 4 is a sectional view schematically showing an example of a scratch mark provided on the magnetic recording medium.

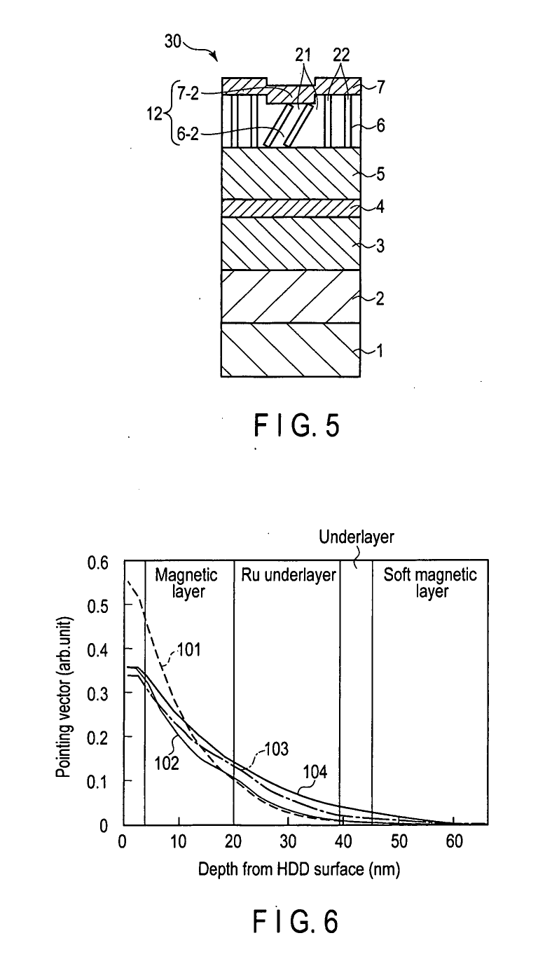

FIG. 5 is a sectional view schematically showing another example of a scratch mark provided on the magnetic recording medium.

Scratch marks formed on the magnetic recording medium have two modes, like scratch marks 11 and 12 shown in FIGS. 4 and 5. When evaluating the scratch mark of the magnetic recording medium, the two modes need to be identified.

In FIGS. 4 and 5, the uneven portions measured by the atomic force microscope (AFM) are assumed to have the same flaw depth.

As shown in FIG. 4, in mode 1, the scratch mark 11 is formed to sink into the plating layer 3 that is about 70 nm deep from the surface, as compared to FIG. 3. Deformed portions 3-1, 4-1, 5-1, 6-1, and 7-1 are formed in the plating layer 3, the underlayer 4, the intermediate layer 5, the magnetic layer 6, and the protective layer 7, respectively. FIG. 4 shows an example in which the scratch mark sinks into the plating layer. A state in which the scratch mark sinks into a layer other than the magnetic layer can be considered as mode 1.

As shown in FIG. 5, in mode 2, the scratch mark 12 is formed when the directions of magnetic particles in the magnetic layer 6 tilt from the vertical direction to an oblique direction, as compared to FIG. 3. Deformed portions 6-2 and 7-2 are formed in the magnetic layer 6 and the protective layer 7, respectively.

In the deformed portion 6-1 in mode 1, even if a concave defect is generated on the medium surface, it does not largely affect magnetic recording/reproduction because the directions of magnetic particles in the magnetic layer 6 remain vertical.

On the other hand, in the deformed portion 6-2 in mode 2, since the direction of magnetic crystal of the magnetic layer 6 tilts from the vertical direction to an oblique direction, the recording/reproduction characteristic greatly degrades.

In the evaluation method according to this embodiment, it is important to identify mode 2 in a short time.

If the magnetic layer makes a plastic deformation, the static magnetic characteristic changes. Hence, the amount of degradation can be measured by measurement using MOKE or MFM. The characteristic degradation amount of the magnetic recording medium can quantitatively be measured by measurement. However, it is difficult to use the measurement for a sampling inspection in the manufacturing process because the measurement takes time.

The reflection intensity of light changes depending on the surface shape and the optical characteristic of the material. In a case in which a flaw such as a scratch mark is formed on a flat substrate or a material with a different optical constant adheres to the substrate, the reflectance at that portion changes, and the defect can be detected. According to the embodiment, if the above-described flaw is formed, which layer of the magnetic recording medium has a hollow is understood, thereby determining whether the flaw degrades the static magnetic characteristic or not only by an optical inspection.

In addition, from the measurement result of the refractive index or extinction coefficient of each material, the reflection intensity of incident light in each layer was calculated for each wavelength of light that has entered from the surface of the magnetic recording medium.

FIG. 6 is a graph showing the relationship between a pointing vector and a depth from the surface of the magnetic recording medium for each wavelength of light.

Referring to FIG. 6, 101 indicates a case in which the wavelength λ of light is 300 nm; 102, a case in which the wavelength λ of light is 500 nm; 103, a case in which the wavelength λ of light is 700 nm; and 104, a case in which the wavelength λ of light is 900 nm.

As can be seen from FIG. 6, the incident light to the magnetic recording medium becomes almost 0 at a position about 40 nm deep from the surface. The reflection intensity is determined by the sum of reflections on the interfaces of the layers. However, reflection in a region 40 nm or more deep from the surface can be neglected.

The difference between the wavelengths is confirmed. The wavelength of 300 nm has a higher incident light intensity than those of other wavelengths on the surface.

Furthermore, a normalized vertical reflectance was evaluated by calculating the reflection intensity for each wavelength from a result obtained by measuring a scratch mark in mode 1 using the white light source.

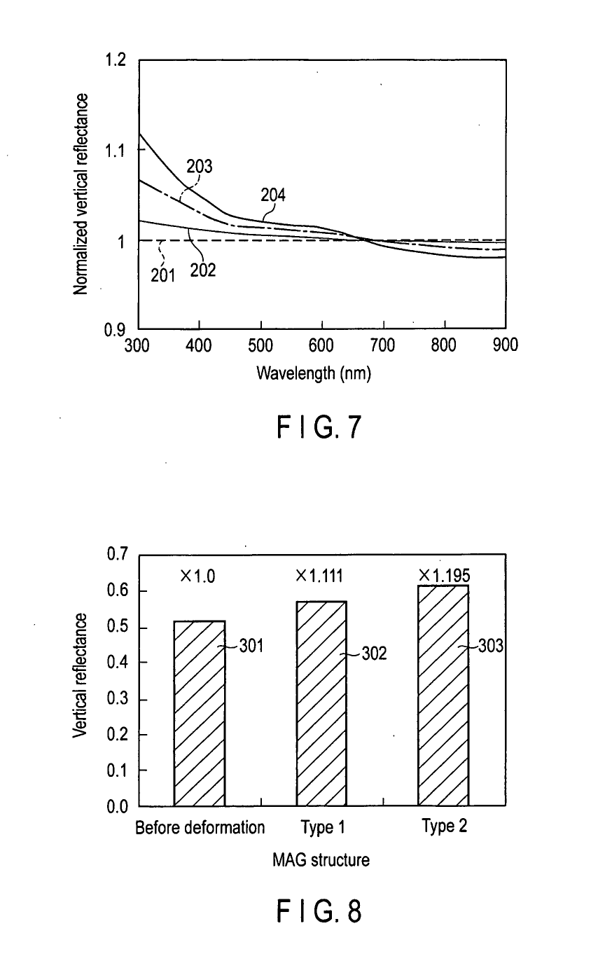

FIG. 7 is a graph showing the relationship between an incident light wavelength and a normalized vertical reflectance with respect to the depth of a scratch mark in mode 1.

Referring to FIG. 7, 201 indicates a case in which no scratch mark is formed, that is, the depth is 0 nm; 202, a case in which the scratch mark depth is 1 nm; 203, a case in which the scratch mark depth is 2 nm; and 204, a case in which the scratch mark depth is 3 nm. The reflectance of each wavelength in each scratch depth was normalized by the reflectance in the case in which no scratch mark is formed, that is, the depth is 0.

As shown in FIG. 7, a change in the surface shape is detected more sensitively at a wavelength of about 300 nm to 500 nm than at other wavelengths. As can be seen, the deeper the scratch mark is, the higher the normalized reflectance is.

On the other hand, in the wavelength range from 600 nm to 700 nm, the reflectance does not increase independently of the depth of the scratch mark, as is apparent.

This reveals that the increase in the reflectance in the region where the reflectance intensity does not rise by a change in unevenness is the increase in the reflectance caused by the tilt of the magnetic layer.

FIG. 8 is a graph showing a vertical reflectance in a wavelength range from 600 nm to 700 nm on a mode basis.

Referring to FIG. 8, 301 indicates a graph before deformation; 302, a graph of type 1 of mode 2; and 303, a graph of type 2 of mode 2.

As shown in FIG. 8, in mode 2, the vertical reflectance increased to 1.1 times or 1.195 times depending on the type, as compared to a case in which a film thickness d of the granular magnetic film before deformation was 14 nm.

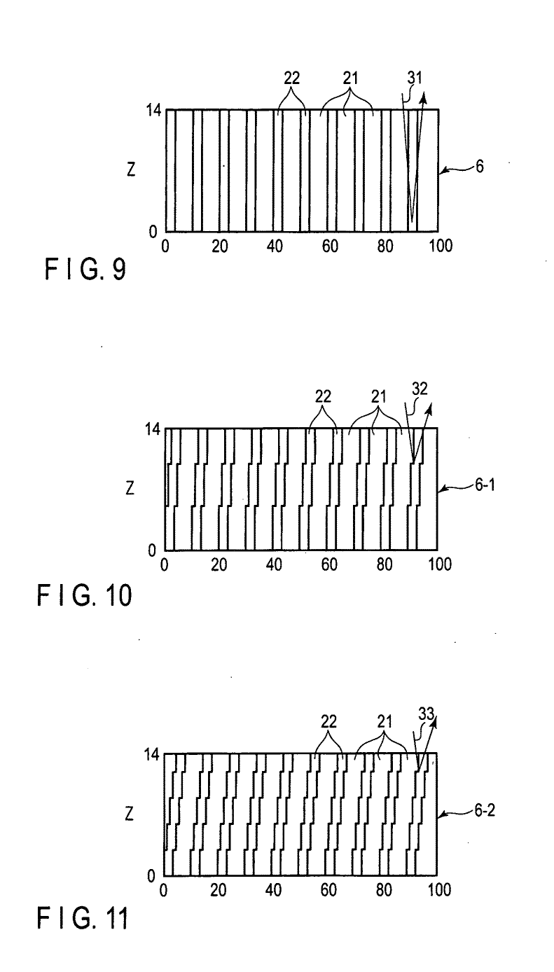

FIGS. 9, 10, and 11 are schematic views for explaining a mechanism configured to increase the vertical reflectance in a wavelength range from 600 nm to 700 nm.

FIG. 9 corresponds to the graph 301 in FIG. 8 and shows the granular magnetic layer 6 in a case in which no scratch mark is formed, that is, the depth is 0 nm or in a case in which a scratch mark in mode 1 is formed. As is apparent, incident light 31 passes deep into a grain boundary 22 of the granular magnetic layer 6 and is then reflected.

FIG. 10 corresponds to the graph 302 in FIG. 8 and shows a granular magnetic layer 6-1 with a scratch mark in mode 2. FIG. 11 corresponds to the graph 303 in FIG. 8 and shows a granular magnetic layer 6-2 with a scratch mark in a case in which a change has further occurred in mode 2.

In FIG. 9, even if a concave defect is formed on the medium surface, the incident light 31 reaches the bottom of the grain boundary 22 of the granular magnetic layer because the granular magnetic layer 6 is directed in the vertical direction, and the perpendicular magnetic anisotropy is affected little, as can be seen.

On the other hand, in FIG. 10 or 11, since the granular magnetic layer 6-2 or 6-3 tilts, the perpendicular magnetic anisotropy degrades. Incident light 32 or 33 hardly passes into the grain boundary 22 of the granular magnetic layer and is reflected in a shallow portion of the grain boundary 22, as can be seen.

As described above, the reflection intensity is low in a case in which no scratch mark is formed, and the incident light passes deep into the grain boundary of the granular magnetic layer or in a case in which a scratch mark is formed but the magnetic phase does not change, as in mode 1. If the granular magnetic layer tilts as in mode 2, the reflection intensity becomes high because the incident light hardly passes into the grain boundary of the granular magnetic layer.

About Granular Film

The magnetic recording medium used in the embodiment has a structure in which an underlayer, an intermediate layer, a granular magnetic layer, and a protective layer are stacked on a substrate. In general, the granular magnetic layer used in the magnetic recording medium indicates a layer having a magnetic phase surrounded by a nonmagnetic material and magnetically isolated. The magnetic recording medium usable in the embodiment has, between the magnetic phase and the nonmagnetic phase, a granular structure made of a material having an optical absorption coefficient difference of at least 10 times. In general, in a region from 300 nm to 900 nm near visible light, the optical absorption coefficient of a material such as Co or Pt that constitutes the magnetic phase has a value or 1 or more. Hence, the optical absorption coefficient of the nonmagnetic phase needs to be at least 0.1 or less. In particular, if the optical absorption coefficient of the nonmagnetic phase is 10⁻² or less, the influence of a structural change of the granular layer can be detected more sensitively. Note that the optical absorption coefficient difference is preferably large because a change in the sink of the granular magnetic layer can be detected sensitively. In particular, the optical absorption coefficient of the grain boundary is preferably as small as possible, and a material whose optical absorption coefficient is almost 0, for example, SiO₂ is preferably used.

About Optical Inspection Method

In an optical inspection method used in the embodiment, an optical inspection apparatus using a wavelength from about 300 nm to about 900 nm as a light source is usable. At least a light source from about 300 nm to 500 nm and a light source from about 600 nm to 700 nm can be used. Two light sources of different wavelengths may be used in separate optical inspection apparatuses. As a light source, a light source having a single wavelength such as a semiconductor laser or gas laser can be used in addition to a white light source such as a halogen lamp or xenon lamp capable of emitting white light including light components in a wavelength range from 300 nm to 500 nm and a wavelength range from 600 nm to 700 nm.

As the optical inspection apparatus used in the embodiment, an image capturing apparatus such as a microscope is usable. In a microscope using a white light source, the flaw resistance of a medium can be evaluated by separating white light into RGB signals after image capturing and comparing their reflection light intensities. In general, R indicates a light wavelength of 700 nm, G indicates a light wavelength of 546.1 nm, and B indicates a light wavelength of 435.8 nm. Alternatively, a laser microscope using a semiconductor laser or the like, a mask defect inspection apparatus including a TDI sensor, an optical surface analyzer used to evaluate the surface shape of an HDD, or the like is usable. In addition, a light-receiving element capable of measuring a reflection light intensity can be provided on the optical inspection apparatus used in the embodiment.

### EXAMPLES

### Example 1

### Thin Flaw Examination by Optical Microscope

On each of eight media under different creation conditions, 15 scratches each having a length of 8 μm were formed at an interval of 0.5 μm under a load of 400 μN, 450 μN, or 500 μN using a triboindenter.

After that, the reflection intensity of each scratch portion was measured using an optical microscope including a white light source.

An obtained image was separated into RGB signals. A medium in which only the B signal increased was defined as a medium that did not degrade the characteristic of the magnetic recording medium, and a medium in which the B, R, and G signals increased was defined as a medium that degraded the characteristic, thereby sorting the flaw resistance of each medium.

As for a time needed for measurement, scratching took about 8 hrs, optical measurement took about 1 hr, and image processing took about 1 hr. The measurement was conducted for a total of 10 hrs, thereby completing scratch mark evaluation.

### Comparative Example 1

### Case in which Examination by Optical Microscope was not Performed

The time needed in a case in which optical inspection is not performed, and AFM and MOKE measurement were performed will be described as Comparative Example 1.

Scratching took about 8 hrs, AFM measurement took about 4 hrs, and MOKE measurement took about 8 hrs. The measurement was conducted for a total of 20 hrs, thereby completing scratch mark evaluation.

### Example 2

### Case in which Laser Microscope was Used

A case in which a laser microscope with a wavelength of 700 nm was used in place of the optical microscope used in Example 1 will be described. The laser microscope can reduce the minimum spot diameter to about 0.2 μm. For this reason, the number of flaws to be formed by a triboindenter can be decreased, and a signal can be detected only from a medium that degrades the characteristic of the magnetic recording medium.

Three scratches each having a length of 8 μm were formed on each medium at an interval of 0.5 μm under a load of 400 μN, 450 μN, or 500 μN. After that, the reflection intensity of each scratch portion was measured using a laser microscope. Only a medium in which the reflection intensity rose was defined as an NG medium and sorted. As for a time needed for measurement, scratching took about 2 hrs, and optical measurement took about 1 hr. The measurement was conducted for a total of 3 hrs, thereby completing scratch mark evaluation.

### Example 3

### Flaw Formation by Particle Injection and Reflectance Measurement by OSA

A case in which particle injection was used as a scratch mark formation method, and OSA was used as a reflectance inspection method will be described. As the particles used in particle injection, silica particles each having a diameter of 1 μm were used. The silica particles were diluted with ethanol and atomized so as to be adhered to a medium. After that, the head was sought on the medium using a spin stand, thereby forming scratch marks on the substrate.

The reflectance of the medium with the scratch marks was measured using OSA. The used OSA is an apparatus including two types of light sources, that is, a 400-nm light source and a 700-nm light source. In a medium with a low scratch NG ratio, 10% of defects detected by the 400-nm light source were detected by defect inspection at a wavelength of 700 nm. On the other hand, in a medium with a high scratch NG ratio, 80% of defects detected by the 400-nm light source were detected by defect inspection at a wavelength of 700 nm.

### Example 4

### Case in which Evaluation was Done Using Only One Light Source

In Example 4, a 632-nm He—Ne-based laser was used as a light source, and the intensity of light reflected by a medium surface was measured.

To form scratch marks on a medium, a triboindenter available from Hysitron was used. Scratching was conducted under a load of 400 μN. As the media, a medium A in which the pressure in depositing a granular magnetic layer was changed to raise the dislocation density in the granular magnetic layer, a medium B with a low dislocation density, and a medium C with a lower dislocation density were used to do evaluation. All deposition processes other than deposition of the granular magnetic layer were the same. When the flaw depth after scratching was measured by AFM, it was found that a flaw 1.7 nm deep was formed on each medium.

The reflectance intensity ratio of a scratch mark portion to a portion without a scratch mark in each medium increased to 1.3 times in the medium A. The reflectance intensity ratio remained unchanged in the media B and C.

As a result, only the medium A can be defined as a medium that degraded the characteristic.

### Example 5

### Case in which Two Light Sources were Used

In Example 5, inspection apparatuses including a 405-nm semiconductor laser using a GaN-based light-emitting element and a 650-nm semiconductor laser using an InGaAlP-based light-emitting element, respectively, was used. Each semiconductor laser includes a light-receiving element and can measure the intensity of light reflected by the surface of a magnetic recording medium.

To form scratch marks on a medium, particle injection was used. In the particle injection, carbon particles each having a diameter of 300 nm were used. The carbon particles were diluted with ethanol and atomized so as to be adhered to the medium. After that, the head was sought on the medium using a spin stand, thereby forming scratch marks on the substrate.

As for the media that were used, a medium A in which the pressure in depositing a granular magnetic layer was changed to raise the dislocation density in the granular magnetic layer, a medium B with a low dislocation density, and a medium C with a lower dislocation density were used to do evaluation. All deposition processes other than deposition of the granular magnetic layer were the same.

First, each medium with the scratch marks was inspected by the apparatus including the 405-nm light source. The reflectance all over the medium was measured, and a region with a change was analyzed. This revealed that 20 scratch marks were formed on the medium A. On the other hand, it was found that 19 scratch marks were formed on the medium B, and three scratch marks were formed on the medium C. As the result of evaluation using the apparatus including the 405-nm light source, the numbers of formed scratch marks were almost the same in the media A, B, and C.

Next, the same media were inspected by the apparatus including the 650-nm light source. The reflectance all over the medium was measured, and a region with a change was analyzed. This revealed that 19 scratch marks were formed on the medium A. On the other hand, it was found that three scratch marks were formed on the medium B, and no scratch marks were detected on the medium C.

Under the conditions of particle injection used in this measurement, when surface defect inspection was conducted at a wavelength from 300 nm to 500 nm, a medium with five or less scratch marks could be considered as a medium having a high flaw resistance. A medium with 10 or more scratch marks was handled as an NG product, and a medium with five to 10 scratch marks was handled as an intermediate quality product.

As the result of the measurement, it was found that the medium C was a medium having a high flaw resistance on which scratch marks were hardly formed, and the number of scratch marks was five or less. On the other hand, as the result of measurement at a wavelength of 405 nm, flaws were readily formed on both the medium A and the medium B, and they were NG products. As the result of measurement at a wavelength of 650 nm, it was found that the medium A with 19 flaws was an NG product, but the medium B could be classified into a medium on which no scratch marks that degraded the magnetic characteristic were formed, though the number of flaws was not zero.

### Example 6

### Case in which Medium Resulted in NG During Drive Driving was Inspected

In Example 6, a case in which a medium resulted in NG during drive driving of an HDD will be described. Since NG during drive driving is caused by various NG factors, evaluation needs to be done stepwise. This evaluation aims at examining the presence/absence of degradation of the magnetic characteristic caused by scratch marks. It is therefore necessary to evaluate first whether a flaw exists on an NG medium.

First, an NG medium was inspected by an apparatus including a light source with a wavelength of 405 nm. If the reflection intensity does not change, and no scratch mark is formed on the NG portion in this inspection, it can be determined that the cause of NG during driving is not a scratch mark.

On the other hand, if a scratch mark is detected on the NG portion by the inspection apparatus including the 405-nm light source, the medium is evaluated by an inspection apparatus having a wavelength of 650 nm. If a scratch mark is found on the NG portion by the inspection apparatus having a wavelength of 650 nm, the cause of NG is assumed to be plastic deformation of the granular magnetic layer. On the other hand, if no scratch mark is found on the NG portion by the inspection apparatus, the depth of the flaw at that portion needs to be examined by AFM. If the flaw depth is 2 nm or more as the result of AFM measurement, the cause of NG may be an increase in the spacing between the head and the medium. If the depth is less than 0.2 nm, more detailed analysis is needed. Additional analysis such as residual magnetization evaluation by MFM or shape evaluation by a cross-section TEM needs to be performed.

### Comparative Example 2

### Case in which Plastic Substrate was Used

In Comparative Example 2, a case in which a plastic substrate was used as a substrate will be described.

As the material, a 2-nm thick polycarbonate (PC) plate that was widely used as a transparent engineering plastic was used. The absorption coefficient of the polycarbonate was 0.00075.

As in Example 1, 15 scratches each having a length of 8 μm were formed on each medium at an interval of 0.5 μm under a load of 100 μN, 150 μN, or 200 μN using a triboindenter. The depths of unevenness were about 1.5 nm, 2 nm, and 3 nm.

After scratch formation, the scratch portions were inspected using an optical inspection apparatus including a white light source.

As a result of defect inspection, the influence of reflected light was large between the PC plate and the optical inspection stage, and the shapes of the scratches formed on the PC plate surface could not be detected.

Hence, a 2-nm thick NiTa layer was formed on the PC plate surface by sputtering, and confirmation was done by an optical inspection apparatus including a white light source. As a result of deposition, the reflection intensity on the PC plate surface increased. However, reflected light between the substrate and the stage was stronger, and the scratch marks could not be detected.

### Comparative Example 3

### Case in which Uniform Metal Layer was Used

In Comparative Example 3, a case in which a 2-nm thick Ni substrate was used as a substrate will be described.

As in Example 1, 15 scratches each having a length of 8 μm were formed on each medium at an interval of 0.5 μm under a load of 400 μN, 450 μN, or 500 μN using a triboindenter. The depths of unevenness were about 1.0 nm, 1.7 nm, and 2.5 nm.

After scratch formation, the scratch portions were inspected using an optical inspection apparatus including a white light source.

As a result of defect inspection, an increase in the reflection intensity caused by the scratch marks was confirmed at a wavelength of about 300 nm to 400 nm. It was found that the reflection intensity increased in accordance with the load applied to form a scratch, that is, the flaw depth of a scratch mark. On the other hand, an increase in the reflectance was not confirmed at a wavelength of about 600 to 700 nm.

### Comparative Example 4

### Case in which Grain Boundary Component was Metal

In Comparative Example 4, a case in which a magnetic recording medium including a granular layer whose nonmagnetic phase mainly contained Cr or C was used will be described.

In the medium used in Comparative Example 4, if the nonmagnetic phase contained Cr, the absorption coefficient of the nonmagnetic phase was 1.3. If the nonmagnetic phase was made of a material mainly containing C, the absorption coefficient of the nonmagnetic phase was 0.7.

As in Example 1, 15 scratches each having a length of 8 μm were formed on each medium at an interval of 0.5 μm under a load of 400 μN, 450 μN, or 500 μN using a triboindenter. The depths of unevenness were about 0.8 nm, 1.5 nm, and 2.0 nm.

After scratch formation, the scratch portions were inspected using an optical inspection apparatus including a white light source.

As a result of defect inspection, an increase in the reflection intensity caused by the scratch marks was confirmed on both media at a wavelength of about 300 nm to 400 nm. It was found that the reflection intensity increased in accordance with the load applied to form a scratch, that is, the flaw depth of a scratch mark.

On the other hand, an increase in the reflectance could not be confirmed at a wavelength of about 600 to 700 nm in both the case in which the nonmagnetic phase was made of Cr and the case in which the nonmagnetic phase was made of C.

### Comparative Example 5

### Case in which Film Thickness of Granular Structure is Large

In Comparative Example 5, a case in which a magnetic recording medium including a granular layer whose nonmagnetic phase mainly contained SiO₂ was used will be described. The optical absorption coefficient of the nonmagnetic phase mainly containing SiO₂ was 0.00025. The film thicknesses of used granular layers were set to 5 nm, 10 nm, 12 nm, 15 nm, 18 nm, 22 nm, 30 nm, 40 nm, and 50 nm. As in Example 1, 15 scratches each having a length of 8 μm were formed on each medium at an interval of 0.5 μm under a load of 500 μN using a triboindenter. The depth of unevenness was about 2.0 nm although the unevenness became slightly deep in accordance with an increase in the film thickness of the granular layer.

The reflectances of the scratch portions of the samples with scratches were measured by an optical inspection apparatus including a white light source.

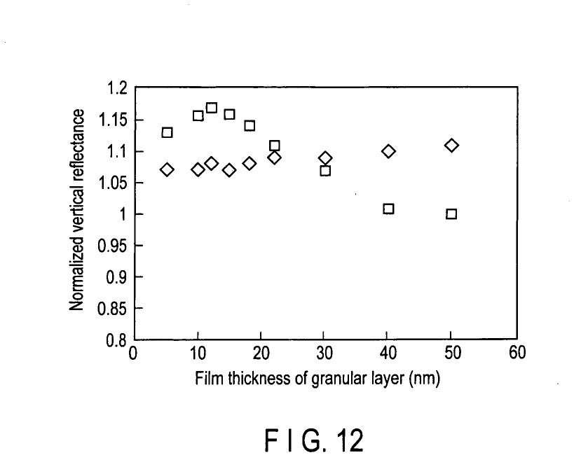

FIG. 12 is a graph showing the relationship between the film thickness of the granular layer and a normalized vertical reflectance at wavelengths of 300 nm and 700 nm.

The normalized reflectance is a value obtained by normalizing the reflection intensity of a scratch portion by the reflectance of a flat portion without a scratch.

Referring to FIG. 12, ⋄ indicates a case in which the medium was irradiated with light having a wavelength of 300 nm, and □ indicates a case in which the medium was irradiated with light having a wavelength of 700 nm.

It was found that at the wavelength of 300 nm, the reflectance intensity slightly increased in accordance with the film thickness of the granular layer. This is probably because the flaw depth of scratches slightly increased along with the increase in the film thickness of the granular layer. On the other hand, it was found that at the wavelength of 700 nm, a peak was formed when the film thickness of the granular layer was about 12 nm, and the normalized reflectance lowered when the film thickness was increased. This is probably because although SiO₂ has a small optical absorption coefficient, the granular structure is not completely directed in the vertical direction, and the effective optical absorption coefficient of the grain boundary increases if the film thickness is 30 nm or more.

As described above, it was found by performing many sample evaluations that the amount of degradation of the characteristic caused by flaws and the reflection intensity of a scratch portion measured by optical inspection have a correlation to some extent. According to the embodiment, when an optical inspection step is inserted in the method of manufacturing a magnetic recording medium like a temporary filter, the number of samples that need to undergo MOKE measurement or the like decreases, and the measurement time can greatly be shortened. As specific characteristic evaluation, evaluation by MOKE or MFM can be used.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of evaluating a scratch mark of a magnetic recording medium, comprising:
applying the magnetic recording medium including a magnetic recording layer containing magnetic particles and a metal oxide grain boundary provided between the magnetic particles to an optical inspection apparatus including a light source configured to emit at least light in a second wavelength range from 600 nm to 700 nm and measuring a second reflection intensity of the light in the second wavelength range; and
detecting and evaluating a scratch mark on a surface of the magnetic recording medium based on a measurement result of the second reflection intensity.

2. The method of claim 1, further comprising:
causing the optical inspection apparatus to emit, from the light source, light in a first wavelength range from 300 nm to 500 nm and measure a first reflection intensity of the light in the first wavelength range; and
detecting and evaluating the scratch mark based on a measurement result of the first reflection intensity.

3. The method of claim 2, wherein the light source includes a first light source configured to emit the light in the first wavelength range and a second light source configured to emit the light in the second wavelength range.

4. The method of claim 3, wherein the first light source comprises a laser light source configured to emit a laser beam in the first wavelength range from 300 nm to 500 nm.

5. The method of claim 3, wherein the second light source comprises a laser light source configured to emit a laser beam in the second wavelength range from 600 nm to 700 nm.

6. The method of claim 2, wherein the light source comprises a white light source,
each of the measuring the light in the first wavelength range and the measuring the light in the second wavelength range comprises capturing the scratch mark on the surface of the magnetic recording medium and separating an obtained image signal into a blue signal, a green signal, and a red signal, and
the first reflection intensity and the second reflection intensity are calculated from the blue signal, the green signal, and the red signal that are separated.

7. The method of claim 1, wherein the scratch mark is formed using particle injection.

8. A method of manufacturing a magnetic recording medium, comprising:
applying the magnetic recording medium including a magnetic recording layer containing magnetic particles and a metal oxide grain boundary provided between the magnetic particles to an optical inspection apparatus including a light source configured to emit at least light in a second wavelength range from 600 nm to 700 nm and measuring a second reflection intensity of the light in the second wavelength range; and
detecting and evaluating a scratch mark on a surface of the magnetic recording medium based on a measurement result of the second reflection intensity.

9. The method of claim 8, further comprising:
causing the optical inspection apparatus to emit, from the light source, light in a first wavelength range from 300 nm to 500 nm and measure a first reflection intensity of the light in the first wavelength range; and
detecting the scratch mark based on a measurement result of the first reflection intensity.

10. The method of claim 8, wherein the light source includes a first light source configured to emit the light in the first wavelength range and a second light source configured to emit the light in the second wavelength range.

11. The method of claim 10, wherein the first light source comprises a laser light source configured to emit a laser beam in the first wavelength range from 300 nm to 500 nm.

12. The method of claim 10, wherein the second light source comprises a laser light source configured to emit a laser beam in the second wavelength range from 600 nm to 700 nm.

13. The method of claim 9, wherein the light source comprises a white light source,
each of the measuring the light in the first wavelength range and the measuring the light in the second wavelength range comprises capturing the scratch mark on the surface of the magnetic recording medium and separating an obtained image signal into a blue signal, a green signal, and a red signal, and
the first reflection intensity and the second reflection intensity are calculated from the blue signal, the green signal, and the red signal that are separated.

14. The method of claim 8, wherein the scratch mark is formed using particle injection.
